(19) United States
(12) Patent Application Publication
(10) Pub. No.: US 2014/0366852 A1
(43) Pub. Date: Dec. 18, 2014

(54) System and Method for Exhaust Gas Re-Circulation

(71) Applicant: Caterpillar Inc., Peoria, IL (US)

(72) Inventors: Matthew J. Liening, Washington, IL (US); Christopher R. Reed, Peoria, IL (US); Dave Ahlman, Peoria, IL (US); Rong Qu, Dunlap, IL (US); Timothy Alcenius, Dunlap, IL (US)

(21) Appl. No.: 13/919,627

(22) Filed: Jun. 17, 2013

(51) Int. Cl. F02M 25/07

(52) U.S. Cl. CPC F02M 25/0722; F02M 25/0714
USPC 123/568.11

(57) ABSTRACT

An exhaust gas re-circulation mixer for use with an engine is disclosed. The exhaust gas re-circulation mixer may include an inlet air port configured to receive inlet air, an outlet configured to release a mixture of the inlet air and exhaust gases and a body integrated with and connecting the inlet air port and the outlet together in fluid communication to form a unitary structure. The body may define a cavity therein for mixing the inlet air and the exhaust gases, the exhaust gas re-circulation mixer being composed of a composite material.

### TECHNICAL FIELD

The present disclosure relates generally to internal combustion engines and, more particularly, relates to exhaust gas recirculation systems and methods for re-circulating exhaust gases within internal combustion engines.

### BACKGROUND

Regulatory emission standards often set limits to the amounts of pollutants, such as nitrous oxides (NOx), which can be released into the environment. Original equipment manufacturers typically meet these limits by incorporating some form of emission reduction technology. One form of emission reduction technology is an exhaust gas recirculation (EGR) system. In this system, a portion of exhaust gases exiting the engine is re-circulated back into the engine cylinders for further combustion. These re-circulated exhaust gases have a low oxygen concentration and can reduce the formation of NOx by lowering the concentration of oxygen in the engine cylinders during combustion.

The EGR system, in at least some instances, may include an EGR mixer that may be mounted to a cylinder head or other inlet system of the engine. The EGR mixer may receive and mix a portion of the exhaust gases with inlet air. The mixed gases from the EGR mixer may be directed back to the engine cylinders to be mixed and combusted with a fuel mixture therein. The flow of exhaust gases through the EGR mixer may be controlled by an EGR valve.

Conventional EGR systems are typically constructed of metal and include several distinct components. For example, the exhaust gases and inlet air may be re-circulated back into the engine through various conduits, manifolds, adapters and spacers that may be connected together to form a conventional EGR system. Designing the EGR system from such distinct metal components not only results in a heavier EGR system, the EGR system is expensive and difficult to manufacture.

Furthermore, depending on the varying engine configurations, different piping and manifold configurations may be needed for the EGR system, which in turn may require the EGR mixer to be oriented in various configurations. For example, in some cases, the EGR mixer may be required to be oriented in an upward facing configuration wherein an inlet of the EGR mixer points in a generally upward direction relative to ground. In some other cases, the EGR mixer may be required to be oriented in a downward facing configuration wherein the inlet of the EGR mixer points in a generally downward direction relative to ground. In yet other cases, alternate configurations where the EGR mixer may be oriented in different directions may be desired as well.

One prior art EGR system is disclosed in U.S. Pat. No. 6,173,701 assigned to Nissan Motor Co., Ltd. The EGR system of this patent comprises an EGR pipe and an EGR valve that connect to a plastic intake manifold of an internal combustion engine. The plastic intake manifold has formed thereon a mounting seat having a cylindrical hole connected with the interior of the intake manifold. A cooling housing constructed of metal is connected to the mounting seat of the intake manifold and an EGR valve is connected to the cooling housing. One end of the EGR pipe is connected to the EGR valve and the other end of the EGR pipe is connected to an exhaust manifold of the engine, such that part of exhaust gas in the exhaust manifold is led to the EGR valve through the EGR pipe to be fed back in to the engine through the cylindrical hole in the mounting seat of the plastic intake manifold. Thus, the EGR system of the '701 patent is complex in design and composed of several components, at least some of which are constructed of metal.

It would accordingly be beneficial if an improved EGR system with fewer parts to reduce the complexity and manufacturing costs of the EGR system without compromising reliability and durability thereof could be developed. It would further be beneficial if the EGR system could be used in different configurations, such as but not limited to, an upward facing configuration and a downward facing configuration.

### SUMMARY

In accordance with one aspect of the present disclosure, an exhaust gas re-circulation mixer is disclosed. The exhaust gas re-circulation mixer may include an inlet air port configured to receive inlet air, an outlet configured to release a mixture of the inlet air and exhaust gases and a body integrated with and connecting the inlet air port and the outlet together in fluid communication to form a unitary structure. The body may define a cavity therein for mixing the inlet air and the exhaust gases, the exhaust gas re-circulation mixer being composed of a composite material

In accordance with another aspect of the present disclosure, an engine is disclosed. The engine may include a cylinder head and an exhaust gas re-circulation mixer. The exhaust gas re-circulation mixer may be composed of a composite material and may include a body defining an inlet air port, the inlet air port configured to at least one of face generally downward towards ground and face generally upward away from the ground when the exhaust gas re-circulation mixer is mounted to the cylinder head.

In accordance with yet another aspect of the present disclosure, a method of re-circulating exhaust gases released from an exhaust manifold back into to an engine is disclosed. The method may include providing an exhaust gas re-circulation mixer having a body constructed of a composite material and defining an inlet air port, an exhaust air inlet port and an outlet, the exhaust gas re-circulation mixer being positioned between the exhaust manifold and the engine. The method may also include receiving inlet air through the inlet air port, receiving exhaust gases from the exhaust manifold into the exhaust gas re-circulation mixer through the exhaust air inlet port and diverting the exhaust gases away from the inlet air port and towards the outlet. The method may additionally include mixing the inlet air with the exhaust gases within the exhaust gas re-circulation mixer to form an exhaust gas re-circulation mixture that is released through the outlet and routing the exhaust gas re-circulation mixture from the outlet to the engine.

These and other aspects and features of the present disclosure will be more readily understood upon reading the following description when taken in conjunction with the accompanying drawings.

### BRIEF DESCRIPTION OF THE DRAWINGS

FIG. 1 shows a perspective view of an intake side of an engine having mounted thereon an exemplary EGR mixer, the EGR mixer constructed in accordance with at least one embodiment of the present disclosure;

FIG. 2 shows a portion of a perspective view of an exhaust side of the engine of FIG. 1;

FIG. 3 shows a perspective view of the embodiment of the EGR mixer of FIG. 1 in greater detail;

FIG. 4 shows a first section of the embodiment of the EGR mixer of FIG. 3, the first section constructed in accordance with at least one embodiment of the present disclosure;

FIG. 5 shows a second section of the embodiment of the EGR mixer of FIG. 3, the second section constructed in accordance with at least one embodiment of the present disclosure;

FIG. 6 shows a cross-sectional view of the embodiment of the EGR mixer of FIG. 3 taken along line 100-100 thereof;

FIG. 7 shows a cylinder head of the engine of FIG. 1 having the EGR mixer of FIG. 3 mounted thereon in an upward facing configuration, in accordance with one embodiment of the present disclosure; and

FIG. 8 shows a cylinder head of the engine of FIG. 1 having the EGR mixer of FIG. 3 mounted thereon in a downward facing configuration, in accordance with at least one embodiment of the present disclosure.

While the present disclosure is susceptible to various modifications and alternative constructions, certain illustrative embodiments thereof will be shown and described below in detail. It should be understood, however, that there is no intention to be limited to the specific embodiments disclosed, but on the contrary, the intention is to cover all modifications, alternative constructions, and equivalents falling within the spirit and scope of the present disclosure.

### DETAILED DESCRIPTION

The present disclosure provides an EGR system having a composite EGR mixer configured to receive inlet air through an inlet air port and exhaust gases from an engine through an exhaust air inlet port, mix the inlet air and the exhaust gases together within the EGR mixer to form an EGR mixture, and release the EGR mixture through an outlet of the EGR mixer back into the engine. In one embodiment, the EGR mixer may include a first body section and a second body section. Both body sections may be composed of composite material(s) configured to withstand the operational temperatures of the engine without melting. Furthermore, the EGR mixer may be configured to be mounted to the engine and particularly, to a cylinder head of the engine, in multiple configurations, including an upward facing configuration and a downward facing configuration.

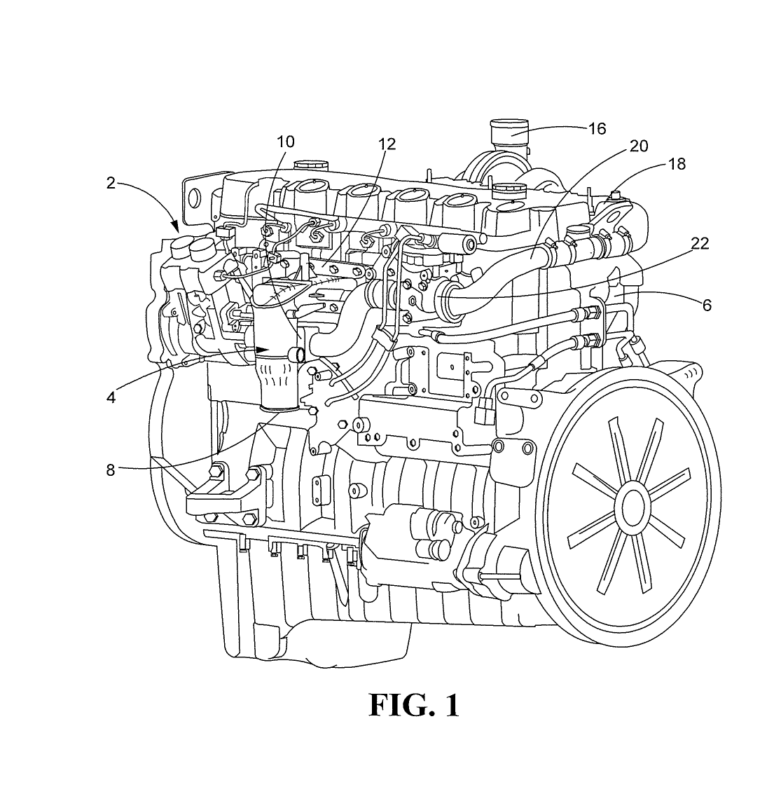

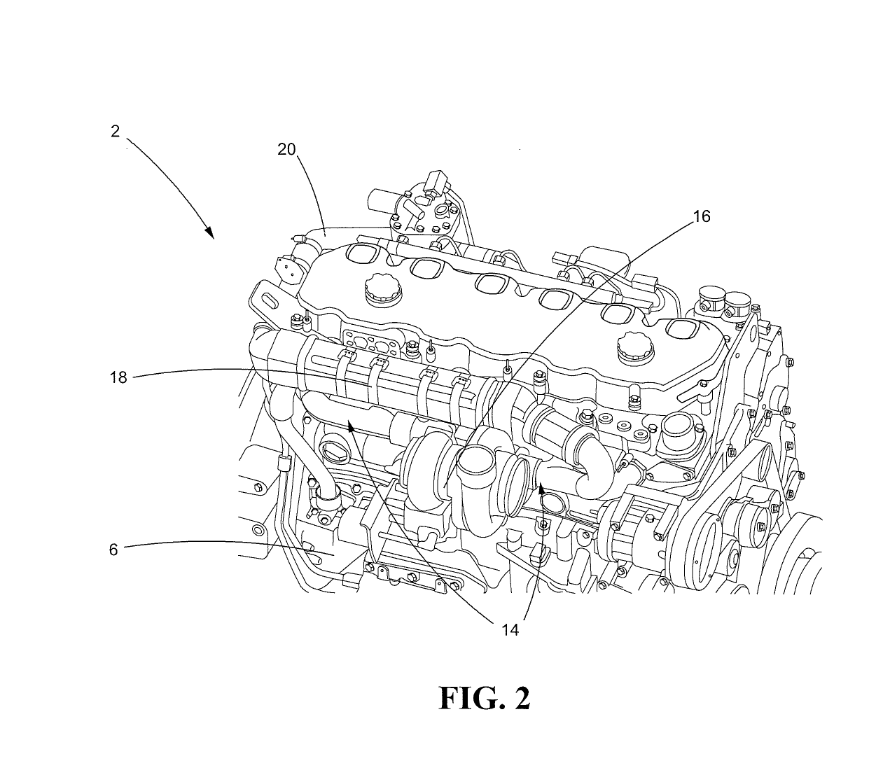

Referring now to FIGS. 1 and 2, side perspective views of an exemplary engine 2 are shown, in accordance with at least some embodiments of the present disclosure. Specifically, FIG. 1 is a perspective view that shows an intake side of the exemplary engine 2, while FIG. 2 shows a portion of an exhaust side of that engine. In at least some embodiments, the engine 2 may be a turbocharged compression ignition engine, commonly known as a diesel engine. In other embodiments, other types of engines on which exhaust gas re-circulation may be desired may be used as well.

The engine 2 may have mounted thereon an exemplary EGR mixer 4. The EGR mixer 4 may be mounted to a cylinder head 6 of the engine 2 and may include an inlet air port 8, an exhaust air inlet port 10 and an outlet 12. The inlet air port 8 may receive a quantity of compressed inlet air, also referred to as boost air or fresh air, from the engine 2, while the exhaust air inlet port 10 may receive exhaust gases that exit the engine 2 through an exhaust manifold 14. In at least some embodiments, the inlet air may be routed through an aftercooler, not shown, before it enters the inlet air port 8 of the EGR mixer 4. Similarly, the exhaust gases from the exhaust manifold 14 may be extracted into the EGR mixer 4 via an exhaust conduit 20 before the remaining gases are routed through a turbocharger 16. An EGR cooler 18 may be used to cool the exhaust gases before they enter the EGR mixer 4. The quantity of exhaust gases entering into the exhaust air inlet port 10 may be controlled by an EGR valve 22.

Upon entering the exhaust air inlet port 10, the exhaust gases may combine with the inlet air entering through the inlet air port 8 to form an EGR mixture. This EGR mixture may then be routed, sometimes through an intake manifold that is not shown in the drawings, into the cylinder head 6 along with injection fuel to be combusted. The combustion process results in the formation of more exhaust gases, which is again routed through the EGR mixer 4 as described above.

It will be understood that only those components of the engine 2 that are necessary for understanding the present disclosure are shown herein. Several other components that are commonly employed in combination or conjunction with the engine 2 and the EGR mixer 4 are nevertheless contemplated and considered within the scope of the present disclosure.

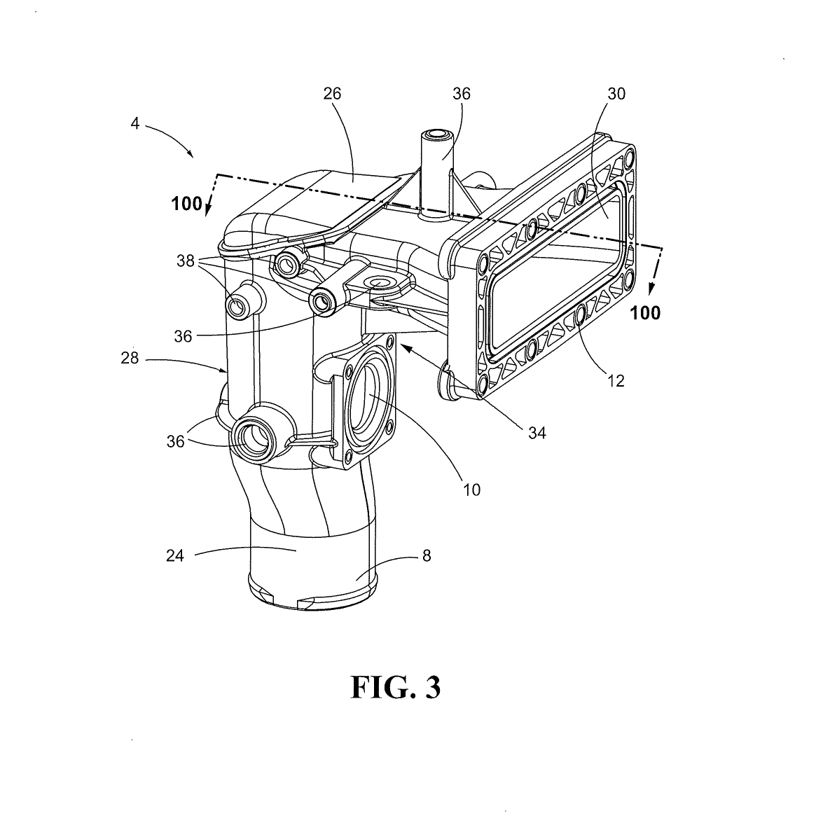

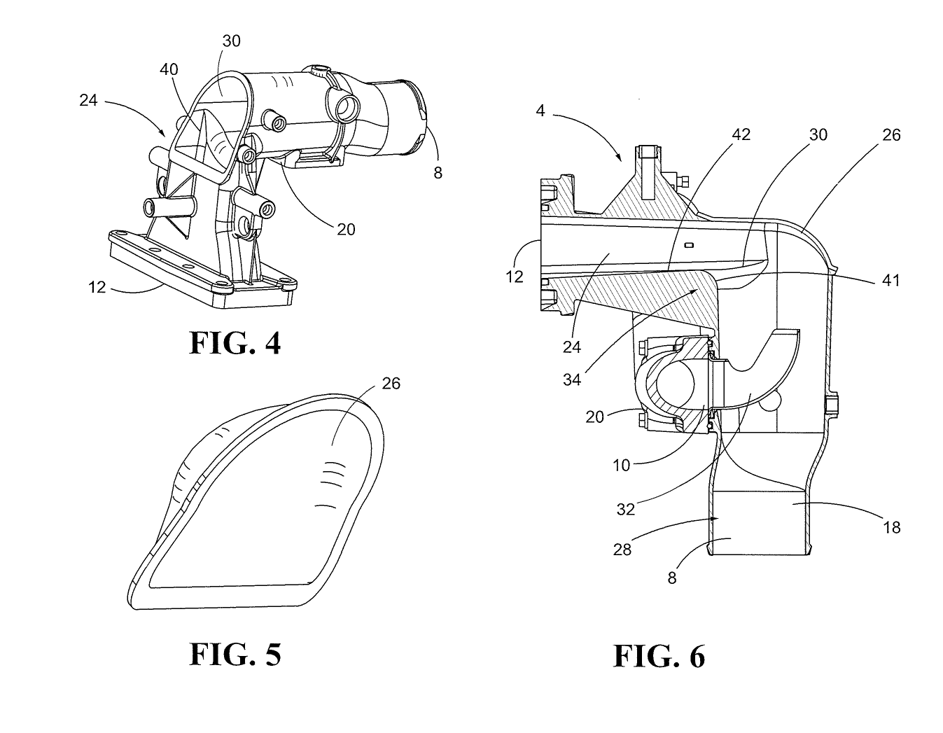

Turning now to FIG. 3 in conjunction with FIGS. 4 and 5, the EGR mixer 4 is shown in greater detail, in accordance with at least some embodiments of the present disclosure. Specifically, FIG. 3 shows a perspective view of the EGR mixer 4 while FIGS. 4 and 5 show first and second body sections, 24 and 26, respectively, of a body 28 of the EGR mixer. As described above, the EGR mixer 4 may include the inlet air port 8 for receiving the inlet air, the exhaust air inlet port 10 for receiving the exhaust gases and the outlet 12 for releasing the EGR mixture back into the cylinder head 6 of the engine 2. It will be understood that although only a single one of the inlet air port 8, the exhaust air inlet port 10 and the outlet 12 have been shown in the present embodiment, multiple numbers of those ports may be provided in other embodiments as may be deemed desirable.

The inlet air port 8, the exhaust air inlet port 10 and the outlet 12 may be in fluid communication with one another through the body 28 defining a cavity 30 therein. The cavity 30 may be configured to receive and mix a pre-determined volume of the inlet air and the exhaust gases. In one embodiment, the cavity 30 may be defined by separately manufacturing the first body section 24 and the second body section 26 of the body 28 and connecting those sections together. An injection molding process may be employed to manufacture the indivisible structures of the first and the second body sections 24 and 26, respectively, which may then be welded together to form the body 28 and the cavity 30. In some embodiments, a vibration welding mechanism may be employed to connect the first body section 24 and the second body section 26 together such that upon welding, those two sections are practically indivisible.

Thus, in at least one embodiment, the EGR mixer 4 and particularly, the body 28 of the EGR mixer may be constructed of only two separate parts, namely, the first body section 24 and the second body section 26 that may be connected together to form the cavity 30 for receiving and mixing the inlet air and the exhaust gases. Constructing the body 28 from only two sections is in contrast to conventional EGR mixers that are composed of several parts connected together.

It will be understood that the body 28 of the EGR mixer 4 is composed of two separate pieces primarily for ease of manufacturability, as will be described further below. In other embodiments and depending upon the mode of manufacture and desired application, the body 28 of the EGR mixer 4 may be composed as a single piece or possibly of more than two pieces as well. Furthermore, notwithstanding the fact that in the present embodiment, the first body section 24 and the second body section 26 have been described as being constructed from an injection molding process and welded together, in at least some embodiments, other mechanisms and/or processes to manufacture and connect the first and the second body sections may be utilized as well.

Moreover, each of the first body section 24 and the second body section 26 may be composed of a composite material that is capable of withstanding the operating temperatures of the engine 2 without melting. For example, in at least some embodiments, each of the first and the second body sections 24 and 26, respectively, may be manufactured from a thermo-composite material such as, but not limited to, glass filled nylon. In other embodiments, other types of reinforced plastics, thermo-composite resins or materials may be utilized for manufacturing the first body section 24 and/or the second body section 26 as well. In addition, the first body section 24 and the second body section 26 need not always be constructed out of the same composite material. In at least some embodiments, each of those body sections may be composed of different types of composite materials and connected together to form the body 28 of the EGR mixer 4.

Utilizing a composite material to construct the body 28 of the EGR mixer 4 is beneficial in several aspects. For example, manufacturing the EGR mixer 4 from a composite material is less expensive than metal, thereby reducing the cost of the EGR mixer relative to conventional EGR mixers and therefore, also reducing the overall cost of the engine 2 employing the EGR mixer. Composite materials are also lighter in weight compared to metals such as aluminum, iron, and steel, which are used to construct conventional EGR mixers. Therefore, the EGR mixer 4, which is composed of a composite material, is lighter in weight compared to conventional EGR mixers. A lighter EGR mixer leads to a lighter engine and, thus, better fuel economy for the vehicles and machines employing the engine 2.

In addition, and as described above, by virtue of using a composite material, the EGR mixer 4 may be constructed of only two (or possibly fewer) parts. This represents a reduction in the number of parts utilized in metal EGR mixers of the prior art, which, as described above, may require a separate inlet, adapter or other mixer components, as well as require various sealing gaskets, rings and connecting mechanisms to connect all the parts together in an air-tight configuration. To the extent that any adapters or other components are employed in the EGR mixer 4, they are integrally formed within the first body section 24.

Thus, the EGR mixer 4 may achieve a similar functionality as the prior art EGR mixers at reduced costs, with fewer parts and a lighter engine. As described further below, constructing the EGR mixer 4 from a composite material may also provide certain design benefits to improve the performance of the EGR mixer, particularly in improving the flow of the inlet air and the exhaust gases therein. Constructing the EGR mixer 4 from a composite material may also eliminate at least some of the vibrations that the EGR mixer 4 may be prone to during operation of the engine.

Referring still to FIGS. 3-5 and particularly, to FIGS. 3 and 4, the first body section 24 of the body 28 of the EGR mixer 4 will now be described. As shown, the first body section 24 may have a substantially L-shaped structure and may have integrally defined therein the inlet air port 8, the exhaust air inlet port 10 and the outlet 12. Notwithstanding the fact that the first body section 24 has been shown and described as having a substantially L-shaped structure, in at least some embodiments, the shape, size and configuration of the first body section 24 may vary.

Furthermore, integrating the inlet air port 8 into the first body section 24 of the body 28 is in contrast to prior art EGR mixers in which the inlet port is typically a separate adapter component attached to the EGR mixer 4 through metal connections. By virtue of integrating the inlet air port 8 into the EGR mixer 4, the use of such adapter components is eliminated and risks such as, leaks, loosening, etc., associated with separate inlet connections is substantially reduced and possibly completely eliminated, thereby improving the reliability and durability of the EGR mixer 4 while reducing the number of parts.

The inlet air entering through the inlet air port 8 may flow towards the exhaust air inlet port 10. Similar to the inlet air port 8, the exhaust air inlet port 10 may also be integrally formed within the first body section 24 of the body 28. Proximate the exhaust air inlet port 10 and within the cavity 30, a deflecting vane 32 (See FIG. 6) may be provided to deflect the exhaust gases entering through the exhaust air inlet port away from the inlet air port 8 and towards an area surrounding an elbow joint 34 of the first body section 24. Around the area of the elbow joint 34, the exhaust gases from the exhaust air inlet port 10 may be mixed with the inlet air from the inlet air port 8 to form the EGR mixture.

The EGR mixture may be released from the cavity 30 of the first body section 24 via the outlet 12, which similar to the inlet air port 8 and the exhaust air inlet port 10, may also be integrally formed within the first body section. Again, by integrating the inlet air port 8, the exhaust air inlet port 10 and the outlet 12, the number of components in the EGR mixer 4 are reduced and the reliability and durability of the EGR mixer is improved.

Furthermore and in addition to the inlet air port 8, the exhaust air inlet port 10 and the outlet 12 described above, the first body section 24 may also include a plurality of additional ports 36. The additional ports 36 may include a sensor port, an air takeoff port and an ether port that may be utilized for measuring different parameters of the EGR mixer 4, for using other components in conjunction with the EGR mixer or for otherwise expanding the functionality thereof. As shown, in one embodiment, the additional ports 36 may be integrally formed during the manufacturing process within the first body section 24 of the body 28. Ports other than those described above may be provided as desired on the EGR mixer 4 in other embodiments. In addition to the additional ports 36, the EGR mixer 4 may also include various mounting locations 38 for wiring harnesses and mounting other components that may be employed in conjunction with the EGR mixer 4.

With respect to the second body section 26, it is shown in greater detail in FIG. 5. As mentioned above, the second body section 26 is a single indivisible piece that may be welded to the first body section 24. The second body section 26 is primarily intended to cover an opening 40 in the first body section 24, the opening being employed to manufacture certain design characteristics within the inner wall surfaces of the first body section to improve the flow of gases within the EGR mixer. These design characteristics are discussed below with respect to FIG. 6. It will be understood that the shape and particular configuration of the second body section 26 that is shown in FIG. 5 is merely exemplary. Similar to the first body section 24, the shape, size and dimensions of the second body section 26 may vary in other embodiments to correspond to the shape, size and configuration of the first body section.

Turning now to FIG. 6, a cross-sectional view of the EGR mixer 4 taken along line 100-100 of FIG. 3 is shown, in accordance with at least some embodiments of the present disclosure. The cross-sectional view in particular illustrates the design characteristics of the first body section 24 that improve the flow of gases therethrough. Specifically, the elbow joint 34 may be configured with an inner radius in the cavity 30 of the first body section 24 having an inclined surface 42 to improve the performance of the EGR mixer 4. More specifically, the inner radius may include a curvature 41 at the elbow joint 34 to reduce resistance to flow of the inlet air and the exhaust gases within the EGR mixer 4. Similarly, the inclined surface 42 may extend from a narrower throat area in the cavity 30 of the elbow joint towards a broader opening of the outlet 12 to reduce the velocity of the inlet air and the exhaust gases passing through the area of the elbow joint.

By virtue of reducing the velocity of and resistance to the flow of the inlet air and the exhaust gases, the pressure drop of those fluids within the EGR mixer 4 is lowered and accordingly, the performance of the EGR mixer is improved due to improved fluid flow. The design of the curvature 41 of the inner radius is possible at least in part due to the use of a composite material to construct the first body section 24. The opening 40 in the first body section 24 may be utilized to design the curvature 41 and the inclined surface 42 of the inner radius during the manufacturing process.

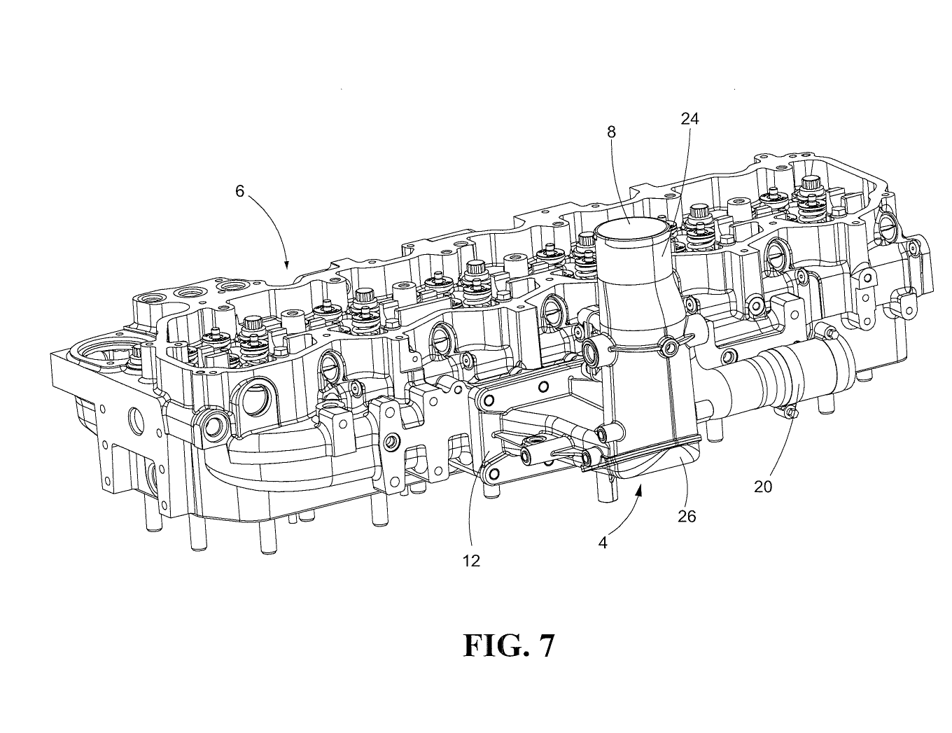

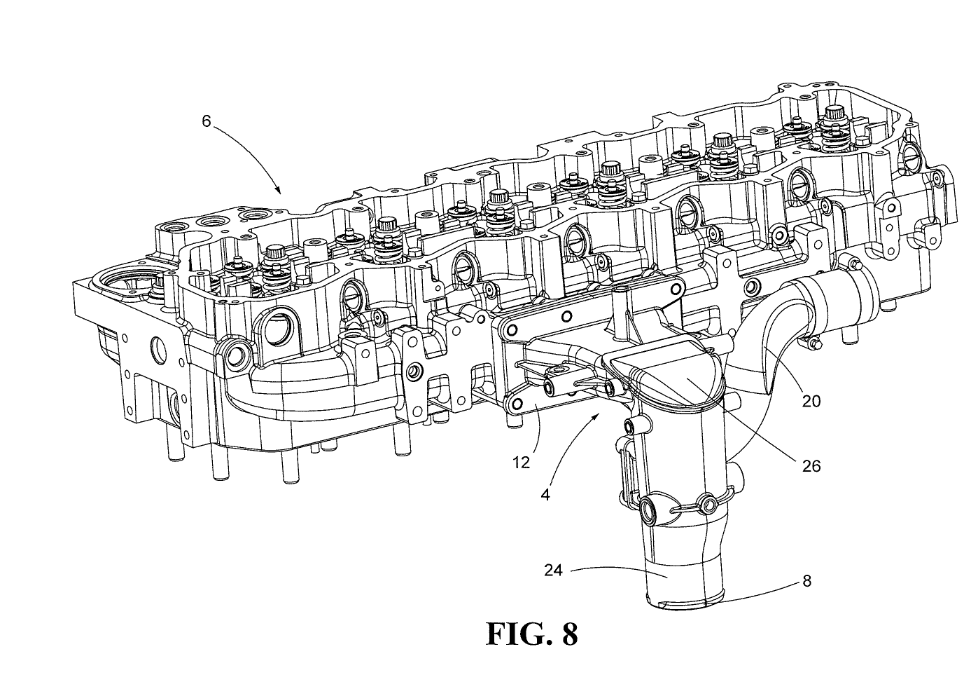

Referring now to FIGS. 7 and 8, the EGR mixer 4 is shown installed on the cylinder head 6 of the engine 2, in accordance with at least some embodiments of the present disclosure. Specifically, FIG. 7 shows the EGR mixer 4 installed on the cylinder head 6 in an upward facing configuration, while FIG. 8 shows the EGR mixer installed on the cylinder head in a downward facing configuration. As used herein, the “upward facing configuration” means that the EGR mixer 4 may be installed on the cylinder head 6 such that the inlet air port 8 of the EGR mixer is pointing in a generally upward direction relative to ground. Relatedly, the “downward facing configuration” means that the EGR mixer 4 may be installed on the cylinder head 6 such that the inlet air port 8 of the EGR mixer is pointing in a generally downward direction relative to ground.

Furthermore, the EGR mixer 4 may be installed on the cylinder head 6 of the engine 2 via the outlet 12 of the EGR mixer 4. In at least some embodiments, the outlet 12 may be directly connected, such as through bolts, to the cylinder head 6. No additional components may be needed between the cylinder head 6 and the outlet 12 of the EGR mixer 4, such that the EGR mixture exiting the EGR mixer enters the engine directly without having to pass through any additional components. A variety of sealing mechanisms, such as O-rings, rubber rings or gaskets, etc. may be employed to achieve an air tight and secure connection of the EGR mixer 4 to the cylinder head 6.

Although not shown, in at least some other embodiments and as desired, the EGR mixer 4 may be attached directly to an intake manifold or some other component, such as a valve cover base with integrated air passage, which may in turn be attached to the cylinder head 6. By virtue of connecting the EGR mixer 4 directly to the cylinder head 6 or to the intake manifold/valve cover base, the need for any adapters or spacers that are commonly employed in conventional EGR mixers is eliminated.

Thus, the same EGR mixer 4 may be employed in both the upward facing configuration of FIG. 7 and the downward facing configuration of FIG. 8. This is at least in part possible due to integrating several components of the EGR mixer into a unitary structure composed of a composite material. It will be understood that although the EGR mixer 4 has been shown and described as being oriented in the upward facing or downward facing configurations, this is merely exemplary. In at least some embodiments, the EGR mixer 4 may be oriented in various other directions in between the upward facing configuration and the downward facing configuration as may be deemed appropriate for a particular engine configuration.

It will again be understood that only those components of the engine 2 that are necessary for an understanding of the present disclosure and the area where the EGR mixer 4 is installed are shown in the present embodiment. Nevertheless, several other components of the engine that may be used in combination or conjunction with the EGR mixer to achieve the full functionality thereof are contemplated and considered within the scope of the present disclosure.

### INDUSTRIAL APPLICABILITY

In general, the present disclosure sets forth a composite EGR mixer for mixing exhaust gases with inlet air and recirculating the mixture back into the engine. The EGR mixer may include a first body section and a second body section, both of which may be connected together to form a body. Each of the first and second body sections may be constructed out of composite material(s). The first body section may have integrally formed therein an inlet air port for receiving inlet air, an exhaust air inlet port for receiving exhaust gases from an exhaust manifold of an engine and an outlet for releasing a mixture of the inlet air and the exhaust gases.

By virtue of integrating several parts together in one piece, the EGR mixer provides an improvement over conventional prior art EGR mixers. Specifically, the EGR mixer not only reduces exhaust emissions to ensure compliance with local regulatory emission standards, the EGR mixer is economical to manufacture, requires fewer parts and improves performance relative to conventional EGR mixers. Moreover, the same EGR mixer maybe employed in multiple configurations. The EGR mixer may be particularly useful in low cost engines where the overall cost of the engine is a concern. Further, the engine may achieve an improved fuel economy due to the low weight of the EGR mixer and, therefore the overall lower weight of the engine.

Additionally, in at least some embodiments, the EGR mixer may be employed without exhaust gas recirculation where emission regulations do not require an EGR mixer. In those instances, the exhaust port for receiving the exhaust gases of the EGR mixer may be covered and the EGR mixer may be used as an air-elbow to direct fresh air into the engine.

While only certain embodiments have been set forth, alternatives and modifications will be apparent from the above description to those skilled in the art. These and other alternatives are considered equivalents and within the spirit and scope of this disclosure and the appended claims.

What is claimed is:

1. An exhaust gas re-circulation mixer, comprising:
an inlet air port configured to receive inlet air;
an outlet configured to release a mixture of the inlet air and exhaust gases; and
a body integrated with and connecting the inlet air port and the outlet together in fluid communication to form a unitary structure, the body defining a cavity therein for mixing the inlet air and the exhaust gases, the exhaust gas re-circulation mixer being composed of a composite material.

2. The exhaust gas re-circulation mixer of claim 1, wherein the composite material is glass filled nylon.

3. The exhaust gas re-circulation mixer of claim 1, wherein the composite material does not melt at engine operating temperatures.

4. The exhaust gas re-circulation mixer of claim 1, further comprising an exhaust air inlet port for receiving the exhaust gases into the exhaust gas re-circulation mixer.

5. The exhaust gas re-circulation mixer of claim 1, wherein the body is designed with an inner radius having a curvature at an elbow joint of the body, the inner radius configured to reduce a pressure drop of the inlet air and the exhaust gases within the exhaust gas re-circulation mixer.

6. The exhaust gas re-circulation mixer of claim 5, wherein the inner radius includes an inclined surface to gradually expand the cavity of the body from the elbow joint of the body to the outlet thereof, the inclined surface configured to reduce the pressure drop of the inlet air and the exhaust gases within the exhaust gas re-circulation mixer.

7. The exhaust gas re-circulation mixer of claim 1, wherein the body comprises a first body section and a second body section connected together to form a unitary structure.

8. The exhaust gas re-circulation mixer of claim 1, wherein the inlet air port of the exhaust gas re-circulation mixer is oriented in a plurality of positions relative to ground when the exhaust gas re-circulation mixer is mounted to an engine.

9. The exhaust gas re-circulation mixer of claim 8, wherein the inlet air port is configured to face generally towards the ground when the exhaust gas re-circulation mixer is mounted to the engine.

10. The exhaust gas re-circulation mixer of claim 8, wherein the inlet air port is configured to face generally away from the ground when the exhaust gas re-circulation mixer is mounted to the engine.

11. An engine, comprising;
a cylinder head; and
an exhaust gas re-circulation mixer composed of a composite material and including a body defining an inlet air port, the inlet air port configured to at least one of face generally downward towards ground and face generally upward away from the ground when the exhaust gas re-circulation mixer is mounted to the cylinder head.

12. The engine of claim 11, wherein the exhaust gas re-circulation mixer is mounted directly to the cylinder head.

13. The engine of claim 11, wherein the body of the exhaust gas re-circulation mixer defines an exhaust air inlet port configured to receive exhaust gases from an exhaust conduit.

14. The engine of claim 13, wherein the exhaust gas re-circulation mixer includes a deflecting vane within a cavity of the body and proximate to the exhaust air inlet port for diverting the exhaust gases entering through the exhaust air inlet port away from the inlet air port.

15. The engine of claim 11, wherein the body includes a first body section and a second body section, the first body section defining the inlet air port and an exhaust air inlet port and the second body section configured to define an inner radius within the first body section, the inner radius configured to reduce a pressure drop of inlet air and exhaust gases flowing through the exhaust gas re-circulation mixer.

16. A method of re-circulating exhaust gases released from an exhaust manifold back into to an engine, the method comprising:
providing an exhaust gas re-circulation mixer having a body constructed of a composite material and defining an inlet air port, an exhaust air inlet port and an outlet, the exhaust gas re-circulation mixer being positioned between the exhaust manifold and the engine;
receiving inlet air through the inlet air port;
receiving exhaust gases from the exhaust manifold into the exhaust gas re-circulation mixer through the exhaust air inlet port and diverting the exhaust gases away from the inlet air port and towards the outlet;
mixing the inlet air with the exhaust gases within the exhaust gas re-circulation mixer to form an exhaust gas re-circulation mixture that is released through the outlet; and
routing the exhaust gas re-circulation mixture from the outlet to the engine.

17. The method of claim 16, wherein mixing the inlet air with the exhaust gases comprises reducing a pressure drop of the inlet air and the exhaust gases flowing through the exhaust gas re-circulation mixer.

18. The method of claim 16, wherein the exhaust gas re-circulation mixer is configured to be mounted to the engine such that the inlet air port faces in a generally downward direction relative to ground.

19. The method of claim 16, wherein the exhaust gas re-circulation mixer is configured to be mounted to the engine such that the inlet air port faces in a generally upward direction relative to ground.

20. The method of claim 16, wherein the exhaust gas re-circulation mixer is directly installed to a cylinder head of the engine.
